(19) United States
(12) Patent Application Publication
(10) Pub. No.: US 2026/0085958 A1
(43) Pub. Date: Mar. 26, 2026

(54) MEASURING CHAMBERS FOR INGREDIENT DISPENSERS

(71) Applicant: Jened LLC, Washington, DC (US)

(72) Inventors: Edward Ertel, Washington, DC (US); Zachary Carlins, Boston, MA (US); Yen Wei Lee, Boston, MA (US)

(73) Assignee: Jened LLC, Washington, DC (US)

(21) Appl. No.: 19/270,720

(22) Filed: Jul. 16, 2025

Related U.S. Application Data
(60) Provisional application No. 63/698,800, filed on Sep. 25, 2024.

(51) Int. Cl. G01F 19/00

(52) U.S. Cl. CPC G01F 19/00

(57) ABSTRACT

Embodiments disclosed herein are related to measuring chambers configured for use in ingredient dispensers that may dispense a measured amount of dry and/or liquid ingredient. In some embodiments, a measuring chamber may include a receptacle defining an internal volume configured to contain a measured amount of ingredient. The measuring chamber may also include measurement indicators located on the receptacle configured to indicate a numeric value associated with a measurement volume of ingredient contained within the receptacle. The measuring chamber may be removably engageable with an ingredient dispenser such that the measuring chamber may receive a measured amount of dispensed ingredient, and then a user may dispense the measured amount of ingredient from the measuring chamber.

### RELATED APPLICATIONS

This application claims priority under 35 U.S.C. § 119(e) to U.S. Provisional Ser. No. 63/698,800 , filed Sep. 25, 2024, and entitled “MEASURING CHAMBERS FOR INGREDIENT DISPENSERS,” which is incorporated herein by reference in its entirety for all purposes.

### FIELD

Disclosed embodiments are related to measuring chambers for use with ingredient dispensers.

### BACKGROUND

Various types of ingredient dispensers have been employed for use in containing select amounts of dry or liquid ingredients that may then be dispensed for use by a user to enhance meals or meal prep. Such ingredient dispensers typically include a receptacle to store the dry or liquid ingredients as well as an outlet to permit dispensing of said ingredients.

### SUMMARY

In some embodiments, a measuring chamber configured for use with an ingredient dispenser is provided. The measuring chamber may include a receptacle defining an internal volume configured to contain a measured amount of ingredient. The measuring chamber may also include a plurality of measurement indicators located on the receptacle. In some embodiments, the plurality of measurement indicators may be configured to indicate a numeric value associated with a measurement volume of the ingredient contained within the receptacle. The measuring chamber may also include one or more protuberances positioned within the internal volume of the receptacle, and the one or more protuberances may be configured to adjust the distribution of the ingredient contained within the receptacle. In some embodiments, the one or more protuberances may be constructed and arranged such that a spacing between at least a portion of the plurality of measurement indicators is increased relative to a configuration without the one or more protuberances.

In some embodiments, a measuring chamber configured for use with an ingredient dispenser is provided. The measuring chamber may include a receptacle defining an internal volume configured to contain a measured amount of ingredient. The measuring chamber may also include a plurality of measurement indicators located on the receptacle, and the measurement indicators may be configured to indicate a numeric value associated with a measurement volume of the ingredient. In some embodiments, the measuring chamber may be removably engageable to the ingredient dispenser such that the receptacle is configure to receive the measured amount of ingredient from the ingredient dispenser.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a perspective view of a measuring chamber engaged with an ingredient dispenser, according to some embodiments;

FIG. 1B is a cross-sectional perspective view of the measuring chamber and ingredient dispenser of FIG. 1A taken along lines 1A-1A, according to some embodiments;

FIG. 2A is a front perspective view of a retrofittable measuring chamber configured for use with the ingredient dispenser of FIGS. 1A-1B, according to some embodiments;

FIG. 2B is a rear perspective view of the retrofittable measuring chamber of FIG. 2A, according to some embodiments;

FIG. 3 is a perspective view of a measuring chamber engaged with an ingredient dispenser, according to some embodiments;

FIG. 4A is a schematic view of a mode of engagement between a measuring chamber and an ingredient dispenser, according to some embodiments; and

FIG. 4B is a schematic view of a mode of engagement between a measuring chamber and an ingredient dispenser, according to some embodiments.

### DETAILED DESCRIPTION

Ingredient dispensers are commonly used to dispense dry or liquid ingredients for applications such as cooking and adjusting the level of desired taste preference in a plated dish. However, traditional ingredient dispensers have disadvantages, including that the amount of ingredient cannot be easily measured as it is dispensed. This may cause an excess of ingredient or a lack of ingredient to be inadvertently dispensed for the user. While measuring devices such as measuring spoons and measuring cups are able to provide the ability to measure a select amount of ingredient, these measuring devices are not integrated with receptacles that contain dry or liquid ingredients, and therefore must be employed separately from the ingredient dispensers to measure select amounts of ingredient.

In view of the above, the inventors have recognized that there is a need for ingredient dispensers which dispense measured amounts of dry or liquid ingredients for a user, as will be appreciated by the various embodiments disclosed herein. In addition, the inventors have recognized that there is a need for measuring chambers that may be configured to engage conventional ingredient dispensers and provide an easily readable measurement for the dispensed dry or liquid ingredients.

In some embodiments, a measuring chamber according to embodiments disclosed herein may be retrofittable to commercially available ingredient dispensers (e.g., a spice bottle) such as ingredient dispensers marketed by the McCormick® company of Hunt Valley, Cockeysville, MD, USA. That is, a measuring chamber as disclosed herein may be constructed and arranged to be engageable with a variety of commercially available ingredient receptacles having varied opening sizes and shapes. The measuring chamber may be engaged with a corresponding ingredient dispenser in any suitable fashion (e.g., via an interference fit, a threaded fit, a snap fit, etc.) such that the measuring chamber receptacle may be integrated with the ingredient dispenser to receive dispensed ingredient. It should be appreciated that the present disclosure is not limited to embodiments with a retrofittable measuring chamber, as embodiments of the measuring chamber disclosed herein may be configured to attach to any ingredient dispenser whether preexisting or specially designed to be employed with the measuring chamber.

The inventors have also recognized benefits associated with providing a measuring chamber that includes measurement indicators (e.g., volume markings and measurement lines) that are sufficiently spaced and oriented on the measuring chamber to improve visualization of measured ingredient for the user. That is, the inventors have appreciated that measurement line spacing may be too small such that it could be difficult for a user to read a given measurement volume. For example, smaller measurement volumes such as 1 tsp, ½ tsp, ¼ tsp may have smaller measurement line spacings therebetween such that the user may have difficulty in reading the measured amount of ingredient.

In some embodiments, a measuring chamber may include a receptacle defining an internal volume configured to contain a measured amount of ingredient. In some embodiments, the measuring chamber may include a plurality of measurement indicators located on the receptacle that may be configured to indicate a numeric value associated with a measurement volume of ingredient contained within the receptacle. The inventors have recognized benefits associated with positioning the measurement indicators (e.g., volume markings and measurement lines) at a sufficient distance from one another along the receptacle to aid in visualization of the measured ingredient for the user. In some embodiments, such positioning and line spacing of the indicators may be accomplished by including a protuberance in the measuring chamber receptacle that is configured to adjust the distribution of ingredient received in the receptacle, which may in turn allow for the measurement indicators to be spaced at a greater distance on the receptacle to improve readability for the user. The geometry of the protuberance may be designed to promote relatively equal spacing between measurement lines (for example measurement lines of ¼ tsp, ½ tsp, 1 tsp, 2 tsp) despite the large variance in actual measured volume between these lines (for example ¼ tsp, ½ tsp, 1 tsp of measured volume between these measurement lines). This relatively equal spacing allows the markings to be larger and more legible, but also is a more visually appealing and uniform design.

The ingredient contained within the measuring chamber may then be dispensed at a later time and location as desired by the user. The accumulated ingredient may be dispensed from the measuring chamber in any suitable fashion as the disclosure is not so limited. For example, a flip lid may be provided on the measuring chamber, and the lid may be opened by a user to dispense the accumulated ingredient. In another example, the measuring chamber may be removably engageable with the ingredient dispenser such that the user can dispense the accumulated ingredient directly from the opening of the measuring chamber that is typically engaged to the dispenser.

The measuring chamber may be of any suitable size, shape, or other characteristic to allow a user to measure an amount of ingredient, as the disclosure is not so limited. For example, the measuring chamber may have any suitable shape including, but not limited to cylindrical, hemispherical, a rectangular prism, an ellipsoidal prism, conical, or any other suitable shape, as the disclosure is not so limited.

The measuring chamber may also be constructed of any suitable material including, but not limited to plastics (e.g., polyethylene terephthalate (PET), polypropylene (PP), high density polyethylene (HDPE)), glass, metals, or any other suitable material. In some embodiments, the measuring chamber may by clear, or at least partially transparent to permit a user to see the amount of ingredient contained with the receptacle. In other embodiments, however, the measuring chamber may be frosted or at least partially opaque such that the internal volume of the measuring chamber receptacle is at least partially obscured.

Without wishing to be bound by theory, any suitable dry or liquid ingredients may be used in the ingredient dispenser and subsequently received in the measuring chamber accordingly to embodiments disclosed herein. In some embodiments, a suitable dry ingredient for use in an ingredient dispenser may include, but is not limited to whole spices (e.g., peppercorns, salt), ground spices (e.g., ground pepper), sugar, yeast, salt, baking soda, baking powder, cocoa powder, yeast, flour, or any other suitable dry ingredient as the disclosure is not so limited. In some embodiments, the ingredient dispenser may grind the ingredients as they are dispensed into the measuring chamber. In some embodiments, a suitable liquid ingredient for use in an ingredient dispenser may include, but is not limited to oils, vinegar, soy sauce, liquid sugars, liquid sweeteners, liquid extracts, flavorings, or any other suitable liquid ingredient as the disclosure is not so limited.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

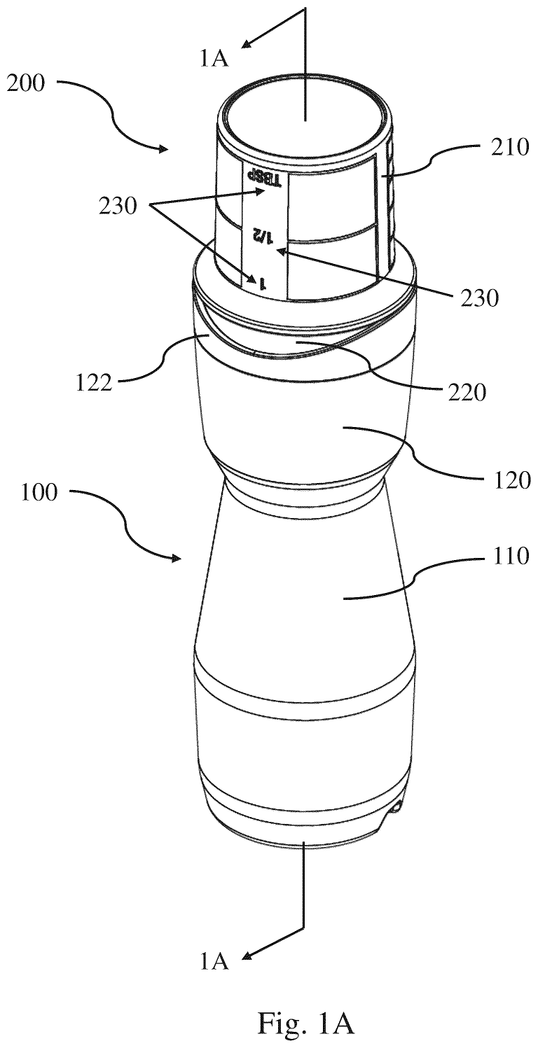

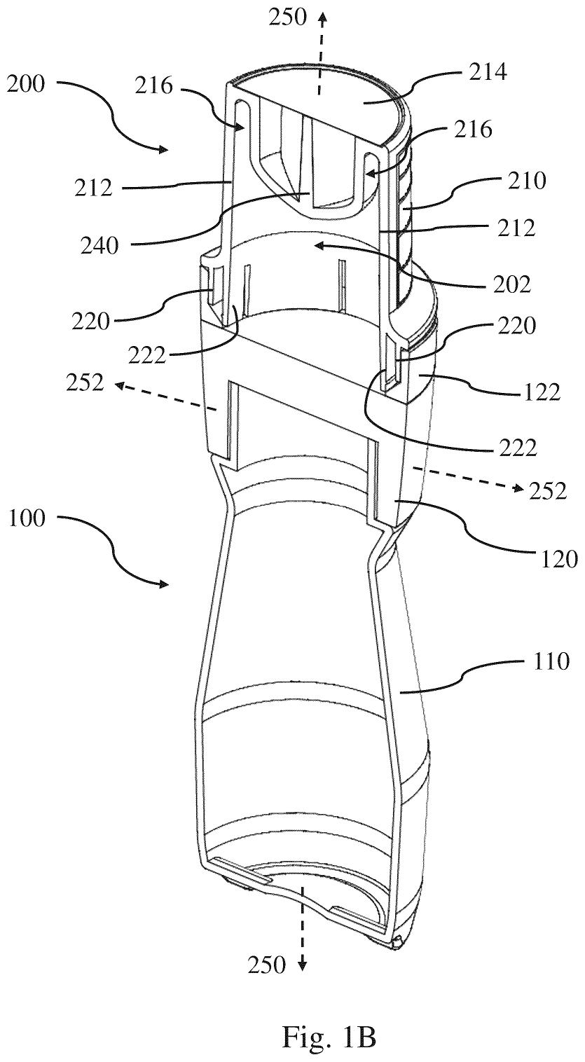

FIG. 1A shows a perspective view of a measuring chamber 200 engaged with an ingredient dispenser 100. The ingredient dispenser 100 may include an ingredient dispenser receptacle 110 configured to contain a dry or liquid ingredient, a dispensing portion 120 configured to dispense the ingredient from the receptacle 110, and an end portion 122, which may be engaged to one another in any suitable fashion (e.g., threaded fit, integrally formed with one another, etc.). The measuring chamber 200 may include a receptacle 210 and an end portion 220 extending therefrom. As shown in FIG. 1A, the end portion 122 may be constructed and arranged as a mouth defining an internal volume that is configured to be engaged with the end portion 220 of the measuring chamber 200. That is, an exterior surface of the end portion 220 may contact an interior surface of the end portion 122 to secure the measuring chamber 200. The dispensing portion 120 may be configured to dispense ingredient stored in the receptacle 110 into the measuring chamber receptacle 210. In some embodiments, the dispensing portion may include a rotatable collar configured to be actuated by a user to grind whole dry ingredient (e.g., peppercorns) stored in the receptacle 110 to dispense ground dry ingredient (e.g., ground pepper) into the measuring chamber receptacle 210. For example, the dispensing portion 120 may include a burr (e.g., a conical burr) configured to rotate relative to a sidewall of the dispenser to grind the whole dry ingredient. While such an example is disclosed, any suitable grinding mechanism may be employed. In another example, the dispensing portion 120 may be configured to dispense ingredient without grinding such as via a valve mechanism that may selectively open the space between the receptacle 110 and the measuring chamber receptacle 210 in response to a user input to allow for the ingredient to be dispensed.

In some embodiments, the measuring chamber 200 may include a plurality of measurement indicators 230 located on the receptacle 210, and the measurement indicators may indicate a numeric value associated with a measurement volume of ingredient contained within the receptacle. That is, the measuring chamber may include volume markings to allow a user to identify the amount of ingredient that has been dispensed into the measuring chamber. For example, the measuring chamber may include markings indicating different measurement amounts such as ⅛ teaspoon (tsp), ¼ tsp, ½ tsp, 1 tsp, ½ tablespoon (tbsp), ⅔ tbsp, 1 tbsp, 2 tbsp, 4 tbsp, or greater. While these measurement amounts are disclosed, any suitable measurement amount may be indicated on the measuring chamber depending on the volume of the measuring chamber provided for a given ingredient dispenser. The markings may be placed at any desired orientation and/or location on the measuring chamber or may be placed at a location and/or orientation at least partially dependent on the size and/or shape of the measuring chamber.

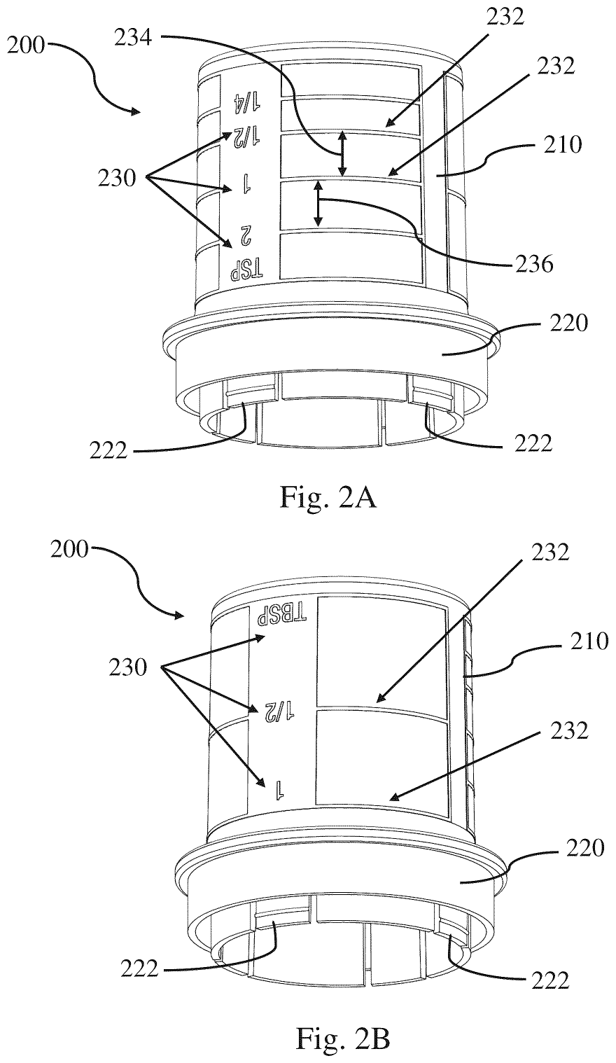

FIG. 1B shows a cross-sectional perspective view of the measuring chamber 200 and ingredient dispenser 100 of FIG. 1A. As shown in FIG. 1B, the measuring chamber 200 may include one or more protuberances 240 positioned within an internal volume of the measuring chamber. In some embodiments, the one or more protuberances 240 may extend from a base 214 of the measuring chamber receptacle 210. In some embodiments, the one or more protuberances 240 may be configured to adjust the distribution of ingredient contained within the measuring chamber. That is, the protuberances may occupy space within the internal volume 202 of the measuring chamber receptacle 210 to adjust the location within the internal volume where the dispensed ingredient may accumulate. The inventors have recognized that such a configuration may serve to aid the user in visualization of the ingredient as it accumulates in the internal volume 202. In particular, smaller amounts of ingredient (e.g., ¼ tsp, ½ tsp, 1 tsp, etc.) may first accumulate within a channel 216 adjacent to the protuberance 240 and the accumulated ingredient may be distributed such that the ingredient occupies a greater amount of vertical space (e.g., in the direction of vertical axis 250) relative to a configuration without the protuberance. As a result, the corresponding measurement indicators 230 (shown in FIG. 1A and FIGS. 2A-2B) may be spaced at a greater distance than a configuration in which the protuberance 240 is not present, which may aid the user in visualizing the various volume markings (e.g., ¼ tsp, ½ tsp, 1 tsp, etc.) associated with a measured amount of the dispensed ingredient.

In some embodiments, at least a portion of the measurement indicators (e.g., volume markings) may be placed at a uniform distance relative to one another. The inventors have appreciated that such a configuration may improve visibility of the individual markings to the user. This may also help the user dispense the desired amount of ingredient more precisely. For example, if the ingredients are dispensed to 1 mm below a given measurement line in this configuration, then the error in measurement will be much less compared to a configuration in which the protuberance 240 is not present where the volume of ingredients that occupy a 1 mm vertical distance is much larger. In other embodiments, however, the measurement indicators may be placed at non-uniform distances relative to one another as the disclosure is not so limited. In some embodiments, the location of the measurement indicators may be adjusted according to the size and/or shape of the one or more protuberances to provide an accurate indication of the measurement volume associated with a given measurement indicator. For example, a larger-sized protuberance may increase the spacing between respective measurement indicators while a smaller-sized protuberance may increase, to a lesser extent, the spacing between respective measurement indicators.

In some embodiments, the shape of the measuring chamber receptacle itself may be non-cylindrical or of another shape where the inner sidewalls 212 of the receptacle 210 are not aligned with respect to the vertical axis 250. For example, the inner sidewalls 212 may have a tapered shape such that the width of the receptacle 210 (e.g., in a direction of horizontal axis 252) is greater adjacent to end portion 220 than the width adjacent to base 214. In another example, the inner sidewalls 212 may have an inversely tapered shape such that the width of the receptacle 210 is greater adjacent to base 214 than the width adjacent to end portion 220. In some such embodiments where the inner sidewalls 212 are not aligned with the vertical axis 250, the internal volume 202 of the receptacle 210 may be unevenly distributed. In such a configuration, the inventors have appreciated that the one or more protuberances may be constructed and arranged to adjust the distribution of the internal volume 202 and thus to adjust the location of the measurement indicators (as shown in FIG. 1A and FIGS. 2A-2B). For example, the protuberances may be used to facilitate an approximately uniform distribution of the measurement indicators despite an uneven distribution of the internal volume of the measuring chamber receptacle. In other cases, the non-vertical inner sidewalls 212 may be used themselves, in lieu of (or in conjunction with) a protuberance, to redistribute the volume of the ingredients, and thus adjust the location of the measurement indicators to more desirable positions and spacings.

In some embodiments, the one or more protuberances 240 may be at least partially curved or angled to urge ingredient contained within the receptacle 210 towards a base 214 of the receptacle (as shown in FIG. 1B). That is, the curved or angled features of the one or more protuberances 240 may urge ingredient into the channel 216. In some embodiments, the angled features may be constructed such that a surface portion of the one or more protuberances is flat, and a first end portion of the flat surface is oriented at a vertically higher position relative to a second end portion of the flat surface. Such a configuration may serve to urge ingredient from the first end portion towards the second end portion and then towards the base 214.

The one or more protuberances may be of any suitable size, shape, number, curvature, material, or other characteristic as the disclosure is not so limited. In some embodiments, a suitable number of protuberances is greater than or equal to 1, 2, 3, 4, 5, or more protuberances. Although FIG. 1B shows the protuberance 240 as extending from the base 214, the protuberance may be positioned within the internal volume 202 in any suitable fashion (e.g., extending from inner sidewall 212, etc.).

In some embodiments, the receptacle 210 (and thus the inner sidewall 212, the base 214, and/or the protuberance 240) may be constructed of a suitable material to reduce clinging of dispensed ingredient to the receptacle. For example, the receptacle may be constructed of a non-conductive material to minimize static electricity that may result in clinging of ingredient, and a suitable non-conductive material may include plastics, glass, or any other suitable material as the disclosure is not so limited. In some embodiments, the inner sidewall 212, the base 214, and/or the protuberance 240 may include a textured finish or a polished finish to reduce static electricity within the receptacle 210.

The measuring chamber 200 may be engaged with the ingredient dispenser 100 in any suitable fashion (e.g., via an interference fit, a threaded fit, a snap fit, etc.). For example, an exterior surface of the end portion 220 may contact an interior surface of the end portion 122 to secure the measuring chamber 200 to the ingredient dispenser 100. In some embodiments, the measuring chamber may include one or more tabs 222 circumferentially arranged around an end portion of the measuring chamber as shown in FIG. 1B. In some such embodiments, the tabs 222 may be configured to contact the end portion 122 of the ingredient dispenser to secure the measuring chamber (in addition or alternatively to the contact between end portion 220 and end portion 122 detailed above). For example, the tabs 222 may be configured to form a snap fit with the end portion 122.

FIGS. 2A-2B show perspective views of a measuring chamber 200 configured for use with the ingredient dispenser 100 of FIGS. 1A-1B. As detailed above in reference to FIG. 1B, the measuring chamber 200 may include one or more tabs 222 circumferentially arranged around an end portion of the measuring chamber for use in securing the measuring chamber to the ingredient dispenser. In some embodiments, the tabs 222 may include one or more ribs protruding therefrom (as shown in FIGS. 2A-2B) to facilitate engagement with the corresponding end of the ingredient dispenser (e.g., to form a snap fit, interference fit, etc.). The tabs may be constructed and arranged in any suitable fashion as the disclosure is not so limited. For example, the tabs may be constructed to have equal or unequal circumferential widths, the tabs may be formed such that gaps are disposed therebetween to provide flexure (as shown in FIGS. 2A-2B), or any other suitable tab configuration as the disclosure is not so limited. In some embodiments, a suitable number of tabs on the measuring chamber may be greater than or equal to 1, 2, 3, 4, 5, 6, 7, 8 or more tabs. In some embodiments, the snap feature may be achieved without any tabs.

As shown in FIGS. 2A-2B, the measuring chamber may include a plurality of measurement indicators 230 in the form of volume markings located on the receptacle 210. The measuring chamber may also include measurement lines 232 associated with respective indicators of the plurality of measurement indicators. In some embodiments, the receptacle 210 may be at least partially transparent or frosted to aid in visualization of the ingredient accumulated within the receptacle 210 relative to the measurement indicators 230 and measurement lines 232.

In some embodiments, the measurement indicators may depict measurement volumes such as ⅛ teaspoon (tsp), ¼ tsp, ½ tsp, 1 tsp, ½ tablespoon (tbsp), ⅔ tbsp, 1 tbsp, 2 tbsp, 4 tbsp, or any other suitable measurement volume as the disclosure is not so limited. In some embodiments, a first side of the measuring chamber receptacle 210 may include a first set of volume markings (e.g., teaspoons denoted as “TSP” and shown in FIG. 2A) while a second side of the receptacle 210 may include a second set of volume markings (e.g., tablespoons denoted as “TBSP” and shown in FIG. 2B). While these measurement indicators are shown, any suitable measurement indicators may be used including, but not limited to, ounces, fluid ounces, or any other suitable unit of measurement.

In some embodiments, measuring chamber receptacle 210 may be constructed and arranged to maintain a certain distance between measurement indicators to aid in visualization of ingredient for the user as disclosed herein. That is, the inventors have recognized benefits associated with constructing the measuring chamber such that the variety of measurement indicators (teaspoon volume markings, tablespoon volume markings, etc.) are sufficiently spaced from each other to aid the user in reading the measurement volume. As disclosed herein, in one embodiment, one or more protuberances may be positioned in the measuring chamber receptacle, and a size of the one or more protuberances depends on the desired distribution of the measurement indicators.

If a measuring chamber includes a relatively constant cross-sectional size, then the indicator spacing for smaller volume amounts may be insufficiently small, rendering it difficult to read the indicators. However, if the cross-sectional size changes (for example, increases) for larger volumes, then the indicator spacing for the smaller volumes can be sized to replicate the indicator spacing for the larger volumes. For example, if a measuring chamber lacked a protuberance such as those disclosed herein, then then spacing between, for example, the ¼ teaspoon measurement indicator and the ½ teaspoon measurement indicator may be too close, rendering it difficult for the user to read. However, with a protuberance occupying some space in the measuring chamber, the distance between the measurement indicators would be sufficiently spaced apart to enable the user to more readily see the difference and more accurately measure the appropriate quantity of ingredient. As the size of the protuberance decreases near the top of the measuring chamber (i.e., the cross-sectional size of the measuring chamber increases), more of the volume of the measuring chamber is available for the ingredient and thus the spacing between the indicators nearest the top would decrease relative to the amount of desired ingredient, That is, the spacing between, for example, 1 teaspoon and 2 teaspoons (even though the volume difference is four times ¼ teaspoon) may be about the same spacing between ½ teaspoon and 1 teaspoon (even though the volume difference here is only two times ¼ teaspoon). For such an example, the spacing between the measurement indicators may be denoted as first spacing 234 (the spacing between ½ teaspoon and 1 teaspoon) and second spacing 236 (the spacing between 1 teaspoon and 2 teaspoons), as shown in FIG. 2A.

In some embodiments, the spacing of the measurement indicators relative to the amount of ingredient desired may be quantified as a ratio of about 1:1. That is, for each desired increment of the indicators, the spacing between the indicators remains roughly the same regardless of the increasing volume of ingredient. It should be appreciated therefore that this ratio may depend on the size and/or shape of the receptacle itself or the size and/or shape of any protuberances positioned within the receptacle. In this fashion, the distribution of measurement indicators may improve legibility of the indicators for a user.

In some embodiments, the ratio of the spacing distance to desired volume may range from 0.8:1 to 1.2:1, though other suitable ratios may be employed. In embodiments, the ratio may be 0.8:1, 0.9:1, 1:1, 1.1:1 or 1.2:1.

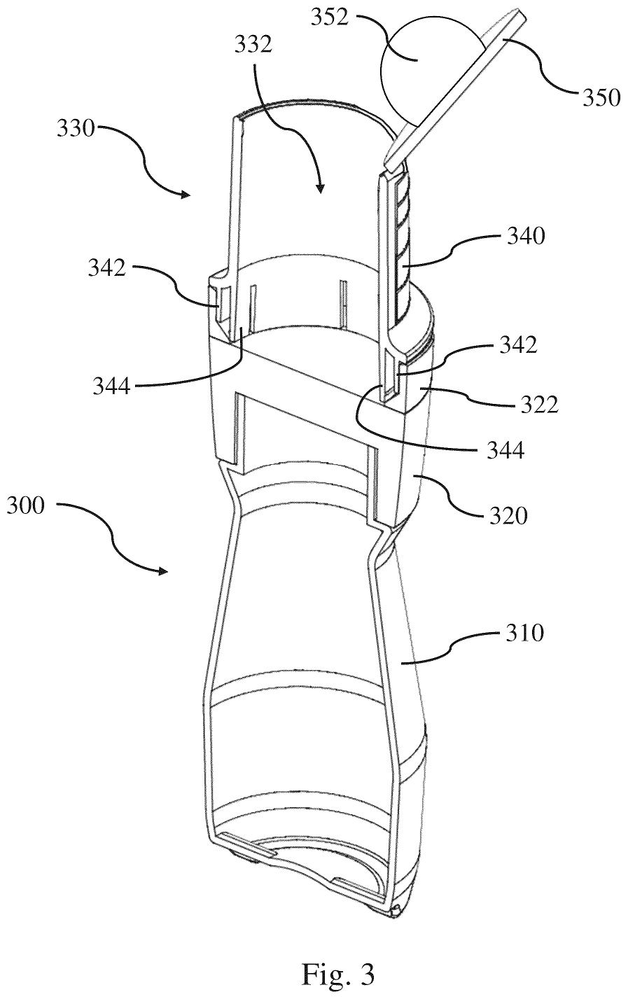

FIG. 3 shows a perspective view of another embodiment of a measuring chamber 330 engaged with an ingredient dispenser 300. The ingredient dispenser 300 may include an ingredient dispenser receptacle 310, a dispensing portion 320, and an end portion 322 which may be engaged to one another in any suitable fashion (e.g., threaded fit, integrally formed with one another, etc.). The measuring chamber 330 may include a receptacle 340 and an end portion 342 extending therefrom. As shown in FIG. 3, the end portion 322 may be constructed and arranged as a mouth defining an internal volume that is configured to be engaged with the end portion 342 of the measuring chamber 330. That is, an exterior surface of the end portion 342 may contact an interior surface of the end portion 322. As disclosed herein, the measuring chamber may include one or more tabs 344 circumferentially arranged around an end portion of the measuring chamber as shown in FIG. 3. In some such embodiments, the tabs 344 may be configured to contact the end portion 322 of the ingredient dispenser to secure the measuring chamber to the ingredient dispenser via a suitable mode of engagement (e.g., an interference fit, a snap fit, etc.). The measuring chamber 330 may be engaged with the ingredient dispenser 300 in any suitable fashion (e.g., via an interference fit, a threaded fit, a snap fit, etc.).

As shown in FIG. 3, the measuring chamber 330 may include a flip lid 350 which may be moved between a closed configuration in which ingredient accumulated in the receptacle 340 may not be dispensed and an open configuration in which the ingredient may be dispensed from the receptacle 340. Although a hinged design is shown in FIG. 3, the flip lid may be opened or removed for dispensing in a variety of ways as the disclosure is not so limited. The flip lid 350 may include a protuberance 352 extending outwardly from a base surface of the flip lid 350. As disclosed herein, in some embodiments, the protuberance 352 may be configured to adjust the distribution of ingredient contained within the measuring chamber in the closed configuration, as mentioned above with respect to the function of the protuberance 240. In addition, the location of corresponding measurement indicators (not shown) disposed on the receptacle 340 may be adjusted according to the size and/or shape of the protuberance 352 to provide an accurate indication of the measurement volume associated with a given measurement indicator. That is, the protuberance 352 may occupy a space of the internal volume 332 when in the closed configuration such that the location and spacing between the measurement indicators may be adjusted to accurately indicate the measurement volume. Although a flip lid 350 is shown in FIG. 3, in some embodiments, the measuring chamber may be removable from the ingredient dispenser to allow for the user to dispense accumulated ingredient from the opening of the measuring chamber which engages the dispenser.

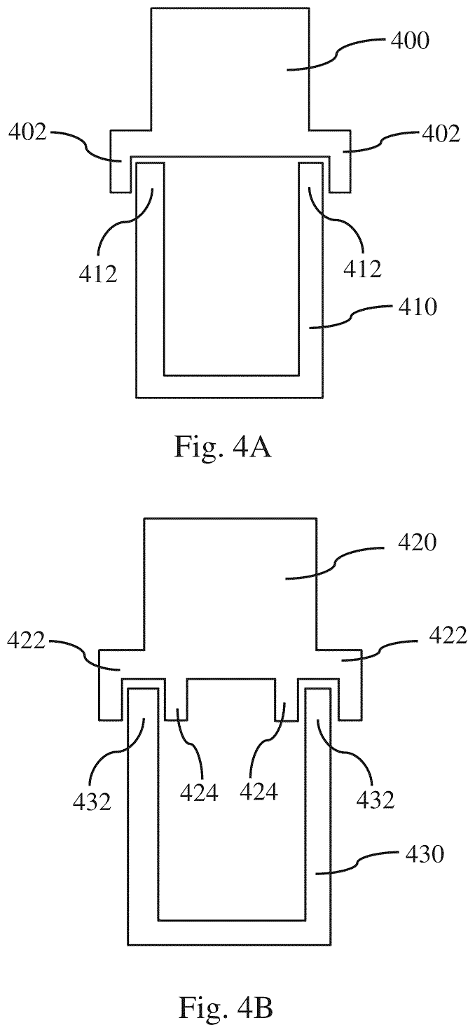

As shown in FIGS. 1A-1B and FIG. 3, an exterior surface of an end portion of the measuring chamber may contact an interior surface of an end portion of the ingredient dispenser to secure the measuring chamber. As disclosed herein, such a configuration may be secured via an interference fit, a threaded fit, a snap fit, or any other suitable fit as the disclosure is not so limited. FIGS. 4A-4B show schematic views of alternative modes of engagement between a measuring chamber and an ingredient dispenser, according to some embodiments. In FIG. 4A, an interior surface of an end portion 402 of a measuring chamber 400 may be engaged with an exterior surface of an end portion 412 of the ingredient dispenser 410. FIG. 4B shows an arrangement where a measuring chamber 420 is engaged to both an exterior surface and an interior surface of an end portion 432 of an ingredient dispenser 430. In particular, the measuring chamber 420 may include an end portion having a first rim 422 and a second rim 424 configured to engage the exterior surface and the interior surface of end portion 432, respectively. In some such embodiments, the measuring chamber 420 may be engaged with the ingredient dispenser 430 via a snap fit.

In some embodiments, the capacity of the measuring chamber may be selectively adjusted for a given dry ingredient dispenser. In some such embodiments, the measuring chamber capacity may be adjusted by providing the measuring chamber with features such as telescoping features (e.g., where the measuring chamber includes two or more portions extendable relative to one another). In addition or alternatively, the measuring chamber capacity may be adjusted by rotating the measuring chamber relative to the ingredient dispenser (e.g., via threaded features). While these adjustment features are disclosed, any other suitable arrangement may be used to adjust the capacity of the measuring chamber as the disclosure is not so limited. Accordingly, the measuring chamber capacity may be adjusted to provide a variety of different measurement volumes including, but not limited to greater than or equal to ⅛ teaspoon (tsp), ¼ tsp, ½ tsp, 1 tsp, ½ tablespoon (tbsp), ⅔ tbsp, 1 tbsp, 2 tbsp, 4 tbsp, or greater. While these measurement amounts are disclosed, measurement amounts which are greater or lesser are also contemplated.

In some embodiments, at least a portion of the measuring chamber may include structural features to indicate a measurement of the ingredient dispensed into the measuring chamber. These structural features may include stepped features, ramped features, conical features (e.g., a cone protruding from a base of the measuring chamber), inverted conical features (e.g., the measuring chamber may have a funnel shape), or any other suitable features as the disclosure is not so limited. For example, stepped features may be provided in the measuring chamber and each “step” of the measuring chamber may correspond to a given measurement amount such as ½ tsp, 1 tsp, 1 tbsp, etc.

The embodiments described herein may be embodied as a method. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A measuring chamber configured for use with an ingredient dispenser, the measuring chamber comprising:
a receptacle defining an internal volume configured to contain a measured amount of ingredient; and
a plurality of measurement indicators located on the receptacle, wherein the plurality of measurement indicators are configured to indicate a numeric value associated with a measurement volume of the ingredient contained within the receptacle;
one or more protuberances positioned within the internal volume of the receptacle, wherein the one or more protuberances are configured to adjust the distribution of the ingredient contained within the receptacle, and wherein the one or more protuberances are constructed and arranged such that a spacing between at least a portion of the plurality of measurement indicators is increased relative to a configuration without the one or more protuberances.

2. The measuring chamber of claim 1, wherein the one or more protuberances include a surface configured to urge the ingredient contained within the receptacle towards a base of the receptacle.

3. The measuring chamber of claim 1, wherein the measuring chamber is configured to be engaged with the ingredient dispenser via at least one of an interference fit, a threaded fit, and a snap fit.

4. The measuring chamber of claim 1, wherein an end portion of the measuring chamber is configured to engage an interior surface of a mouth of the ingredient dispenser to secure the measuring chamber to the ingredient dispenser.

5. The measuring chamber of claim 1, wherein an end portion of the measuring chamber is configured to engage an exterior surface of a mouth of the ingredient dispenser to secure the measuring chamber to the ingredient dispenser.

6. The measuring chamber of claim 1, wherein an end portion of the measuring chamber comprises one or more tabs circumferentially arranged around the end portion, wherein the one or more tabs are configured to engage a mouth of the ingredient dispenser to secure the measuring chamber to the ingredient dispenser.

7. The measuring chamber of claim 1, wherein a sidewall of the receptacle within the internal volume includes a textured finish to reduce clinging of the ingredient to the sidewall of the receptacle.

8. The measuring chamber of claim 1, wherein the measuring chamber is configured to be removably engageable with the ingredient dispenser to permit dispensing of the ingredient from the receptacle.

9. The measuring chamber of claim 1, further comprising a lid portion, wherein the lid portion is configured to be opened to permit dispensing of the ingredient from the receptacle.

10. The measuring chamber of claim 1, wherein at least a portion of the plurality of measurement indicators are spaced at a uniform distance from one another.

11. The measuring chamber of claim 10, wherein the one or more protuberances are constructed and arranged to reduce the internal volume of the receptacle relative to a configuration without the one or more protuberances such that the one or more protuberances cause the uniform distance spacing when positioned within the internal volume of the receptacle.

12. A measuring chamber configured for use with an ingredient dispenser, the measuring chamber comprising:
a receptacle defining an internal volume configured to contain a measured amount of ingredient; and
a plurality of measurement indicators located on the receptacle, wherein the plurality of measurement indicators are configured to indicate a numeric value associated with a measurement volume of the ingredient contained within the receptacle,
wherein the measuring chamber is removably engageable to the ingredient dispenser such that the receptacle is configured to receive the measured amount of ingredient from the ingredient dispenser.

13. The measuring chamber of claim 12, further comprising one or more protuberances positioned within the internal volume of the receptacle, wherein the one or more protuberances are configured to adjust the distribution of the ingredient contained within the receptacle.

14. The measuring chamber of claim 13, wherein the one or more protuberances include a surface configured to urge the ingredient contained within the receptacle towards a base of the receptacle.

15. The measuring chamber of claim 12, wherein an end portion of the measuring chamber is configured to engage an interior surface of a mouth of the ingredient dispenser to secure the measuring chamber to the ingredient dispenser.

16. The measuring chamber of claim 12, wherein an end portion of the measuring chamber is configured to engage an exterior surface of a mouth of the ingredient dispenser to secure the measuring chamber to the ingredient dispenser.

17. The measuring chamber of claim 12, wherein an end portion of the measuring chamber comprises one or more tabs circumferentially arranged around the end portion, wherein the one or more tabs are configured to engage a mouth of the ingredient dispenser to secure the measuring chamber to the ingredient dispenser.

18. The measuring chamber of claim 12, wherein a sidewall of the receptacle within the internal volume includes a textured finish to reduce clinging of the ingredient to the sidewall of the receptacle.

19. The measuring chamber of claim 12, further comprising a lid portion, wherein the lid portion is configured to be opened to permit dispensing of the ingredient from the receptacle.

20. The measuring chamber of claim 13, wherein at least a portion of the plurality of measurement indicators are spaced at a uniform distance from one another.

21. The measuring chamber of claim 20, wherein the one or more protuberances are constructed and arranged to reduce the internal volume of the receptacle relative to a configuration without the one or more protuberances such that the one or more protuberances cause the uniform distance spacing when positioned within the internal volume of the receptacle.

22. The measuring chamber of claim 12, wherein the measuring chamber is engageable to the ingredient dispenser via one of an interference fit, a threaded fit, and a snap fit.
